(19) United States
(12) Patent Application Publication
(10) Pub. No.: US 2010/0328639 A1
(43) Pub. Date: Dec. 30, 2010

(54) SPECTRAL PURITY FILTER, LITHOGRAPHIC APPARATUS, AND METHOD FOR MANUFACTURING A SPECTRAL PURITY FILTER

(75) Inventors: Martin Jacobus Johan Jak, Eindhoven (NL); Vadim Yevgenyevich Banine, Deurne (NL); Maarten Marinus Johannes Wilhelmus Van Herpen, Heesch (NL); Wouter Anthon Soer, Nijmegen (NL); Denis Alexandrovich Glushkov, Alfter (DE); Andrei Mikhailovich Yakunin, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/826,459

(22) Filed: Jun. 29, 2010

Related U.S. Application Data
(60) Provisional application No. 61/222,010, filed on Jun. 30, 2009.
(60) Provisional application No. 61/237,599, filed on Aug. 27, 2009.

(51) Int. Cl. G03B 27/72; G02B 5/20; B29D 11/00

(52) U.S. Cl. 355/71; 359/359; 216/24

(57) ABSTRACT

A transmissive spectral purity filter is configured to transmit extreme ultraviolet radiation. The spectral purity filter includes a filter part having a plurality of apertures to transmit extreme ultraviolet radiation and to suppress transmission of a second type of radiation. The apertures may be manufactured in carrier material such as silicon by an anisotropic etching process and topped with a reflective layer such as Mo metal, Ru metal, TiN or RuO. A diffusion barrier layer such as silicon nitride Si₃N₄, or silicon dioxide SiO₂ is provided between the metal and the semiconductor to prevent diffusion and silicidation of the metal at elevated temperatures. The diffusion barrier layer may also serve as a hydrogen-resistant layer on parts of the semiconductor which are not beneath the reflective layer, and/or enhance emissivity for removal of heat from the structure.

### CROSS-REFERENCE TO RELATED APPLICATIONS

This application claims the benefit of priority from U.S. Provisional Application Ser. Nos. 61/222,010, filed Jun. 30, 2009, and 61/237,599, filed Aug. 27, 2009, the entire contents of both applications are incorporated herein by reference.

### FIELD

The present invention relates to spectral purity filters, lithographic apparatus including such spectral purity filters, and methods for manufacturing spectral purity filters.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of one or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include steppers, in which each target portion is irradiated by exposing an entire pattern onto the target portion at one time, and scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

A key factor limiting pattern printing is the wavelength λ of the radiation used. In order to be able to project ever smaller structures onto substrates, it has been proposed to use extreme ultraviolet (EUV) radiation which is electromagnetic radiation having a wavelength within the range of 10-20 nm, for example within the range of 13-14 nm. It has further been proposed that EUV radiation with a wavelength of less than 10 nm could be used, for example within the range of 5-10 nm such as 6.7 nm or 6.8 nm. Such. EUV radiation is sometimes termed soft x-ray. Possible sources include, for example, laser-produced plasma sources, discharge plasma sources, or synchrotron radiation from electron storage rings.

EUV sources based on a tin (Sn) plasma do not only emit the desired in-band EUV radiation but also out-of-band radiation, most notably in the deep UV (DUV) range (100-400 nm). Moreover, in the case of Laser Produced Plasma (LPP) EUV sources, the infrared radiation from the laser, usually at 10.6 μm, presents a significant amount of unwanted radiation. Since the optics of the EUV lithographic system generally have substantial reflectivity at these wavelengths, the unwanted radiation propagates into the lithography tool with significant power if no measures are taken.

In a lithographic apparatus, out-of-band radiation should be minimized for several reasons. Firstly, resist is sensitive to out-of-band wavelengths, and thus the image quality may be deteriorated. Secondly, unwanted radiation, especially the 10.6 μm radiation in LPP sources, leads to unwanted heating of the mask, wafer and optics. In order to bring unwanted radiation within specified limits, spectral purity filters (SPFs) are being developed.

Spectral purity filters can be either reflective or transmissive for EUV radiation. Implementation of a reflective SPF typically requires modification of an existing mirror or insertion of an additional reflective element. A transmissive SPF is typically placed between the collector and the illuminator and, in principle at least, does not affect the radiation path. This may be an advantage because it results in flexibility and compatibility with other SPFs.

Grid SPFs form a class of transmissive SPFs that may be used when the unwanted radiation has a much larger wavelength than the EUV radiation, for example in the case of 10.6 μm radiation in LPP sources. Grid SPFs contain apertures with a size of the order of the wavelength to be suppressed. The suppression mechanism may vary among different types of grid SPFs as described in the prior art and detailed embodiments further in this document. Since the wavelength of EUV radiation (13.5 nm) is much smaller than the size of the apertures (typically >3 μm), EUV radiation is transmitted through the apertures without substantial diffraction.

Several prior art spectral purity filters (SPFs) rely on a grid with micron-sized apertures to suppress unwanted radiation. U.S. Patent Application Publication 2006/0146413 discloses a spectral purity filter (SPF) comprising an array of apertures with diameters up to 20 μm. Depending on the size of the apertures compared to the radiation wavelength, the SPF may suppress unwanted radiation by different mechanisms. If the aperture size is smaller than approximately half of the (unwanted) wavelength, the SPF reflects virtually all radiation of this wavelength. If the aperture size is larger, but still of the order of the wavelength, the radiation is at least partially diffracted and may be absorbed in a waveguide inside the aperture.

The approximate material parameters and specifications for these SPFs are known. However, manufacturing is not straightforward at these specifications. The most challenging specifications are: apertures of typically 4 μm in diameter; a grid thickness of typically 5-10 μm; very thin (typically <1 μm) and parallel (non-tapered) walls between the apertures to ensure maximal EUV transmission.

Silicon (Si) has emerged as a promising material for the manufacture of such grids, using the photolithographic patterning and anisotropic etching processes that are well-understood from semiconductor manufacturing. For deep apertures with a well-controlled cross-section, deep reactive ion etching (DRIE) has been found promising, although of course problems remain. U.S. Provisional Patent Application No. 61/193,769 filed on Dec. 22, 2008 discloses various methods for manufacture which are applicable in the present invention. The contents of that application are incorporated herein by reference.

While silicon is a promising material for the manufacture of SPFs, various mechanisms associated with contamination management in a real EUV lithography apparatus release hydrogen into the atmosphere, and hydrogen radicals (atomic H) in particular. The inventors have found that that these radicals can decompose the Si filter material and, which may be worse, and also transfer contamination to the critical optical surfaces in the illumination system. Even the best reflective elements for EUV projection reflect a low proportion of the radiation compared with more familiar optical systems. Degradation will seriously limit the yield of a lithographic apparatus. The filter must also withstand heating effects from the various radiation wavelengths.

U.S. Pat. No. 7,031,566 B2 discloses a filter for UV radiation made of ‘macroporous silicon’ in which pores have a diameter d much less than the thickness t of the wafer material. Many prior techniques for manufacturing such structures, both as spectral filters or for other applications, are reviewed. U.S. Pat. No. 7,031,566 B2 proposes to apply a transparent coating of SiO₂ on the sidewalls of the pores for waveguiding of the desired wavelength. Pass-band wavelengths of 200-400 nm are mentioned, for use in analytical instruments, with pores having a diameter around 1 μm and depth around 50 μm. While the text of U.S. Pat. No. 7,031,566 B2 refers in places to ‘extreme UV’, this is not defined and the examples given are not in the sub-20 nm range considered for the present application. Waveguide material SiO₂ is not transparent at the EUV wavelengths mentioned for next-generation photolithography.

Under typical operating conditions, a large amount of power is incident on the spectral purity filter, and therefore the filter may become very hot. In order to test the high-temperature stability, the inventors have heated a prototype filter (molybdenum on silicon) to 800° C. for 24 hours in an oven. Although the grid structure itself remained intact, and the grid still blocked most of the infrared radiation the inventors observed a slight increase in infrared transmission. Detailed analysis of the sample revealed that molybdenum and silicon have diffused and formed a mixed layer of both molybdenum and silicon on the surface, probably molybdenum silicide. This silicide layer was less effective in blocking the IR radiation than the original metal layer. Furthermore, the inventors expect that the absorption of this silicide layer may also be higher, which will result in a higher grid temperature and yet faster silicidation. Therefore this silicide formation is desirably avoided in order to improve both performance and lifetime of the spectral purity filter.

### SUMMARY

It is an aspect of the present invention to provide an EUV spectral purity filter which is effective and easy to manufacture, without the drawbacks associated with silicidation of reflective coatings in a hydrogen radical atmosphere.

According to an embodiment of the present invention, there is provided a spectral purity filter configured to transmit extreme ultraviolet radiation (λ<20 nm), the filter including a filter part having a plurality of apertures to transmit extreme ultraviolet radiation and to suppress transmission of a second type of radiation, the filter part including a carrier material such as silicon. Optionally, the filter part has a thickness smaller than about 20 μm. The spectral purity filter is provided on at least part of its surface with a layer of material opaque to the second type of radiation. The layer of material opaque to the second type of radiation may be provided to a surface of the carrier material of the filter part. Opaque in this context includes reflective and/or absorptive material. Choosing a reflective material will reduce heating of the substrate, which is generally desirable. The layer will be referred to as the reflective layer in examples below, without intending to limit the scope of protection. The opaque material may in particular be a metal such as molybdenum (Mo) metal, reflective to said second type of radiation, and a barrier layer is provided between said opaque material and the carrier material so as to inhibit diffusion of said carrier material into said reflective material under elevated temperatures. The grid-like structure for example comprises a substantially planar filter part having a plurality of apertures, each defined by a side wall extending fully or substantially from a front surface to a rear surface of the filter part. The reflective layer may extend over a front surface and, preferably, part-way down the aperture sidewalls. The carrier material may be a semiconductor.

Typically, the diameter of each apertures is greater than about 2 μm, for instance in the range between about 2 μm and about 10 μm. The apertures may have a period in the range of about 2 μm to about 6 μm. The filter may include an integral filter holder.

The barrier layer can be applied as a coating, or formed by modification of the underlying semiconductor. Example materials are silicon nitride Si₃N₄, silicon dioxide SiO₂, boron carbide B₄C, and silicon carbide SiC. Different materials can be used to protect different parts of the filter, according to ease of manufacture and compatibility with other materials such as reflective coatings. The barrier layer material may be selected to serve also as a hydrogen-resistant material (defined as any material significantly more resistant to radical hydrogen than the semiconductor material). The barrier layer for this purpose may extend over the entire filter part, and not only under the reflective layer.

The spectral purity filter may be of the transmissive type comprising a filter part having a plurality of apertures extending from a front to a rear surface of the filter part to transmit the extreme ultraviolet radiation while suppressing transmission of a second type of radiation. The dimensions of each aperture in the plane of the filter part may be greater than about 2 μm, for example in the range of about 1.5 μm to about 10 μm, or about 1.5 μm to about 4 μm, or about 2 μm to about 3 μm. This size is much greater than the EUV wavelengths of interest, but comparable with the wavelengths of far infrared, for example, which are to be suppressed. The hydrogen-resistant material may cover internal walls of the apertures as well as front and/or rear surfaces.

The spectral purity filter may include a filter part comprising silicon (Si) and having a thickness of about 10 μm, and a plurality of apertures in the filter part, each aperture being defined by a substantially perpendicular sidewall.

According to an embodiment of the present invention, there is provided a lithographic apparatus that includes a radiation source configured to generate radiation comprising extreme ultraviolet radiation, an illumination system configured to condition the radiation into a beam of radiation, and a support configured to support a patterning device. The patterning device is configured to pattern the beam of radiation. The apparatus also includes a projection system configured to project a patterned beam of radiation onto a target material, and a spectral purity filter configured to filter the extreme ultraviolet radiation from other radiation. The spectral purity filter comprises a grid-like structure fabricated in a carrier material such as silicon, and provided on at least part of its surface with a layer of material such as Mo metal, reflective to said second type of radiation. A barrier layer is provided between said reflective material and the semiconductor material so as to inhibit diffusion of said semiconductor material into said reflective material under elevated temperatures. The reflective layer may extend over a front surface and, desirably, part-way down the aperture sidewalls.

According to an embodiment of the present invention, there is provided a method for manufacturing a transmissive spectral purity filter, the method comprising etching a plurality of apertures in a semiconductor or other carrier material substrate using an anisotropic etching process to form a grid-like filter part, and providing on at least part of its surface with a layer of material such as Mo metal, reflective or at least opaque to said second type of radiation, wherein a barrier layer of a different material is provided between said reflective material and the semiconductor material so as to inhibit diffusion of said semiconductor material into said reflective material under elevated temperatures.

Providing the barrier layer may comprise: depositing said different material directly on the semiconductor material of the filter part; depositing a precursor material and processing the filter part to modify said precursor material into the barrier layer material; and/or processing the filter part to modify said semiconductor material into the barrier layer material.

The material of the barrier layer may be formed by modifying the carrier material of the filter part. The barrier layer material may include at least in part SiO₂ and/or Si₃N₄.

According to an embodiment of the present invention, anisotropic etching of the apertures is performed in a silicon substrate using deep reactive ion etching. The silicon substrate has a thickness of about 10 μm, and the apertures have diameters in the range of about 2 μm to about 10 μm, for example, about 2 μm to about 4 μm.

According to a further aspect, there is provided a filter system provided with two or more spectral purity filters and a diffuser. The one or more of these spectral purity filters may be configured to transmit extreme ultraviolet radiation, the spectral purity filter comprising a filter part having a plurality of apertures to transmit extreme ultraviolet radiation and to suppress transmission of a second type of radiation, the filter part comprising a carrier material, the spectral purity filter being provided on at least part of its surface with a layer of material opaque to said second type of radiation. The diffuser may be constructed and arranged to redistribute the second type of radiation. The diffuser may be a further spectral purity filter constructed and arranged to redistribute the second type of radiation. The diffuser may be a further spectral purity filter. Optionally, a barrier layer of different material is provided between said opaque material and the carrier material so as to inhibit diffusion of said carrier material into said opaque material under elevated temperatures.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts schematically a lithographic apparatus according to an embodiment of the invention;

FIG. 2 depicts the layout of the lithographic apparatus of FIG. 1 according to an embodiment of the present invention;

FIG. 3 is a front view of a spectral purity filter in accordance with an embodiment of the present invention;

FIGS. 4A-4E depict a schematic overview of an embodiment of a manufacturing process of a spectral purity filter, prior to formation of a hydrogen-resistant layer;

FIG. 5 is a micrographic image of a tilted cross-section of a spectral purity filter at an intermediate stage of manufacture in accordance with an embodiment of the present invention;

FIG. 6 is a more detailed image of a wall between two apertures in the spectral purity filter of FIG. 5;

FIG. 7 is a top view of part of the spectral purity filter in accordance with an embodiment of the present invention;

FIG. 8 is a schematic cross section of a spectral purity filter incorporating a reflective metal capping but without a diffusion barrier layer;

FIG. 9 is a schematic cross section of a spectral purity filter incorporating a reflective metal capping and a diffusion barrier layer in accordance with an embodiment of the present invention;

FIG. 10 is a schematic cross section of a spectral purity filter incorporating a reflective metal capping and a diffusion barrier layer in accordance with an embodiment of the present invention;

FIG. 11 illustrates a type of process for the manufacture of the spectral purity filter of FIG. 9;

FIG. 12 illustrates a type of process for the manufacture of the spectral purity filter of FIG. 9; and

FIG. 13 schematically depicts a modification of a system including a spectral purity filter.

### DETAILED DESCRIPTION

FIG. 1 depicts schematically the main features of a lithographic apparatus. The apparatus includes a radiation source SO and an illumination system (illuminator) IL configured to condition a radiation beam B (e.g. UV radiation or EUV radiation) from the source. A support MT (e.g. a mask table) is configured to support a patterning device MA (e.g. a mask or a reticle) and is connected to a first positioner PM configured to accurately position the patterning device in accordance with certain parameters. A substrate table (e.g. a wafer table) WT is configured to hold a substrate W (e.g. a resist-coated semiconductor wafer) and is connected to a second positioner PW configured to accurately position the substrate in accordance with certain parameters. A projection system PS is configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The support MT supports the patterning device. It holds the patterning device in a manner that depends on the orientation of the patterning device, the design of the lithographic apparatus, and other conditions, for example whether or not the patterning device is held in a vacuum environment. The support can use mechanical, vacuum, electrostatic or other clamping techniques to hold the patterning device. The support may be a frame or a table, for example, which may be fixed or movable as required. The support may ensure that the patterning device is at a desired position, for example with respect to the projection system.

The term “patterning device” used herein should be broadly interpreted as referring to any device that can be used to impart a radiation beam with a pattern in its cross-section such as to create a pattern in a target portion of the substrate. Generally, the pattern imparted to the radiation beam will correspond to a particular functional layer in a device being created in the target portion, such as an integrated circuit. It should be noted that the pattern imparted to the radiation beam may not exactly correspond to the desired pattern in the target portion of the substrate, for example if the pattern includes phase-shifting features or so called assist features.

The patterning device may be transmissive or reflective. For practical reasons, current proposals for EUV lithography employ reflective patterning devices, as shown in FIG. 1. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

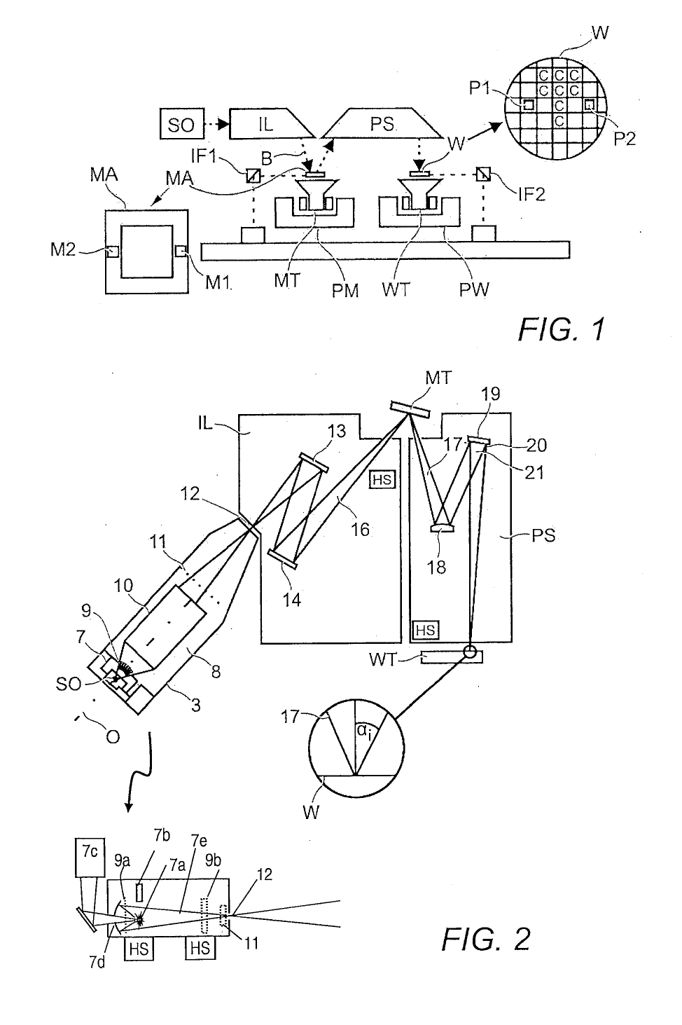

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of a vacuum. It may be desired to use a vacuum for EUV or electron beam radiation since other gases may absorb too much radiation or electrons. A vacuum environment may therefore be provided to the whole beam path with the aid of a vacuum wall and vacuum pumps. An example specific to EUV is described below, with reference to FIG. 2.

Any use of the term “projection lens” herein may be considered as synonymous with the more general term “projection system”. For EUV wavelengths, transmissive materials are not readily available. Therefore “lenses” for illumination and projection in an EUV system will generally be of the reflective type, that is to say, curved mirrors.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located, for example, between the projection system and the substrate during exposure.

Referring to FIG. 1, the illuminator IL receives radiation from radiation source SO. The source and the lithographic apparatus may be separate entities, for example when the source is an excimer laser. In such cases, the source is not considered to form part of the lithographic apparatus and the radiation is passed from the source SO to the illuminator IL with the aid of a beam delivery system (not shown) including, for example, suitable directing mirrors and/or a beam expander. In other cases the source may be an integral part of the lithographic apparatus. The source SO and the illuminator IL, together with the beam delivery system if required, may be referred to as a radiation system.

The illuminator IL may include an adjusting device (adjuster) configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator and a condenser. The illuminator may be used to condition the radiation beam, to have a desired uniformity and intensity distribution in its cross-section.

The radiation beam B is incident on the patterning device MA, which is held on the support MT, and is patterned by the patterning device. After being reflected from the patterning device MA, the radiation beam B passes through the projection system PS, which focuses the beam onto a target portion C of the substrate W. With the aid of the second positioner PW and a position sensor IF2 (e.g. an interferometric device, linear encoder or capacitive sensor), the substrate table WT can be moved accurately, e.g. so as to position different target portions C in the path of the radiation beam. B. Similarly, the first positioner PM and another position sensor IF1 (which may also be an interferometric device, linear encoder or capacitive sensor) can be used to accurately position the patterning device MA with respect to the path of the radiation beam B, e.g. after mechanical retrieval from a mask library, or during a scan.

In general, movement of the mask support MT may be realized with the aid of a long-stroke module (coarse positioning) and a short-stroke module (fine positioning), which form part of the first positioning device PM. Similarly, movement of the substrate table WT may be realized using a long-stroke module and a short-stroke module, which form part of the second positioning device PW. In the case of a stepper, as opposed to a scanner, the support MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, a programmable patterning device MA is kept essentially stationary, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be referred to as “maskless lithography” that utilizes programmable patterning device, such as a programmable mirror array of a type as referred to above.

Combinations and/or variations on the above described modes of use or entirely different modes of use may also be employed.

FIG. 2 shows a schematic side view of a practical EUV lithographic apparatus. It will be noted that, although the physical arrangement is different to that of the apparatus shown in FIG. 1, the principle of operation is similar. The apparatus includes a source-collector-module or radiation unit 3, an illumination system IL and a projection system PS. Radiation unit 3 is provided with a radiation source SO which may employ a gas or vapor, such as for example Xe gas or a vapor of Li, Gd or Sn in which a very hot discharge plasma is created so as to emit radiation in the EUV range of the electromagnetic radiation spectrum. The discharge plasma is created by causing a partially ionized plasma of an electrical discharge to collapse onto the optical axis O. Partial pressures of, for example, 10 Pa or 0.1 m bar of Xe, Li, Gd, Sn vapor or any other suitable gas or vapor may be desired for efficient generation of the radiation. In an embodiment, a Sn source as EUV source is applied.

For this type of source, an example is the LPP source in which a CO₂ or other laser is directed and focused in a fuel ignition region. Some detail of this type of source is shown schematically in the lower left portion of the drawing. Ignition region 7a is supplied with plasma fuel, for example droplets of molten Sn, from a fuel delivery system 7b. The laser beam generator 7c may be a CO₂ laser having an infrared wavelength, for example 10.6 micrometer or 9.4 micrometer. Alternatively, other suitable lasers may be used, for example having respective wavelengths in the range of 1-11 micrometers. Upon interaction with the laser beam, the fuel droplets are transferred into plasma state which may emit, for example, 6.7 nm radiation, or any other EUV radiation selected from the range of 5-20 nm. EUV is the example of concern here, though a different type of radiation may be generated in other applications. The radiation generated in the plasma is gathered by an elliptical or other suitable collector 7d to generate the source radiation beam 7e.

The radiation emitted by radiation source SO is passed from the source chamber 7 into collector chamber 8 via a contaminant trap 9 in the form of a gas barrier or “foil trap”. This will be described further below. Returning to the main part of FIG. 2, collector chamber 8 may include a radiation collector 10 which is, for example, a grazing incidence collector comprising a nested array of so-called grazing incidence reflectors. Radiation collectors suitable for this purpose are known from the prior art. Alternatively, the apparatus can include a normal incidence collector for collecting the radiation. The beam of EUV radiation emanating from the collector 10 will have a certain angular spread, perhaps as much as 10 degrees either side of optical axis O.

Radiation passed by collector 10 transmits through a spectral purity filter 11 according to embodiments of the present invention. It should be noted that in contrast to reflective grating spectral purity filters, the transmissive spectral purity filter 11 does not change the direction of the radiation beam. Embodiments of the filter 11 are described below.

The radiation is focused in a virtual source point 12 (i.e. an intermediate focus) from an aperture in the collection chamber 8. From chamber 8, the radiation beam 16 is reflected in illumination system IL via normal incidence reflectors 13,14 onto a reticle or mask positioned on reticle or mask table MT. A patterned beam 17 is formed which is imaged by projection system PS via reflective elements 18,19 onto wafer W mounted wafer stage or substrate table WT. More elements than shown may generally be present in the illumination system IL and projection system PS. One of the reflective elements 19 has in front of it an NA disc 20 having an aperture 21 there-through. The size of the aperture 21 determines the angle αᵢ subtended by the patterned radiation beam 17 as it strikes the substrate table WT.

FIG. 2 shows the spectral purity filter 11 positioned downstream of the collector 10 and upstream of the virtual source point 12. In alternative embodiments, not shown, the spectral purity filters 11 may be positioned at the virtual source point 12 or at any point between the collector 10 and the virtual source point 12.

The gas barrier includes a channel structure such as, for instance, described in detail in U.S. Pat. Nos. 6,614,505 and 6,359,969, which are incorporated herein by reference. The purpose of this contaminant trap is to prevent or at least reduce the incidence of fuel material or by-products impinging on the elements of the optical system and degrading their performance over time. These elements include the collector 10, and also the collector. In the case of the LPP source shown in detail at bottom left of FIG. 2, the contaminant trap includes a first trap arrangement 9a which protects the elliptical collector 7d, and optionally a further trap arrangements such as shown at 9b. The gas barrier may act as a physical barrier (by fluid counter-flow), by chemical interaction with contaminants and/or by electrostatic or electromagnetic deflection of charged particles. In practice, a combination of these methods may be employed to permit transfer of the radiation into the illumination system, while blocking the plasma material to the greatest extent possible. As explained in the above-mentioned United States patents, hydrogen radicals in particular may be injected for chemically modifying the Sn or other plasma materials.

Hydrogen radicals can also be applied for cleaning of Sn and other which may already be deposited on the optical surfaces. Further, hydrogen gas may be deployed in the vicinity of the wafer support WT, as a buffer against contaminants from the wafer entering the larger vacuum spaces within the system. In a vacuum environment, typical photoresist materials, not to mention components of the supports and positioning systems, tend to release organic and other gaseous materials which could contaminate the optical components over time.

For all these purposes, hydrogen sources HS are shown deployed for the supplying hydrogen gas to each contaminant trap arrangement 9a, 9b, and at ports to the chambers of the illumination system IL and projection system PS. Some sources may supply molecular hydrogen gas (H₂) as a simple buffer while others generate H radicals. The molecular hydrogen which permeates the vacuum environment can become radicalized by radiation, electric discharge and so forth in the environment.

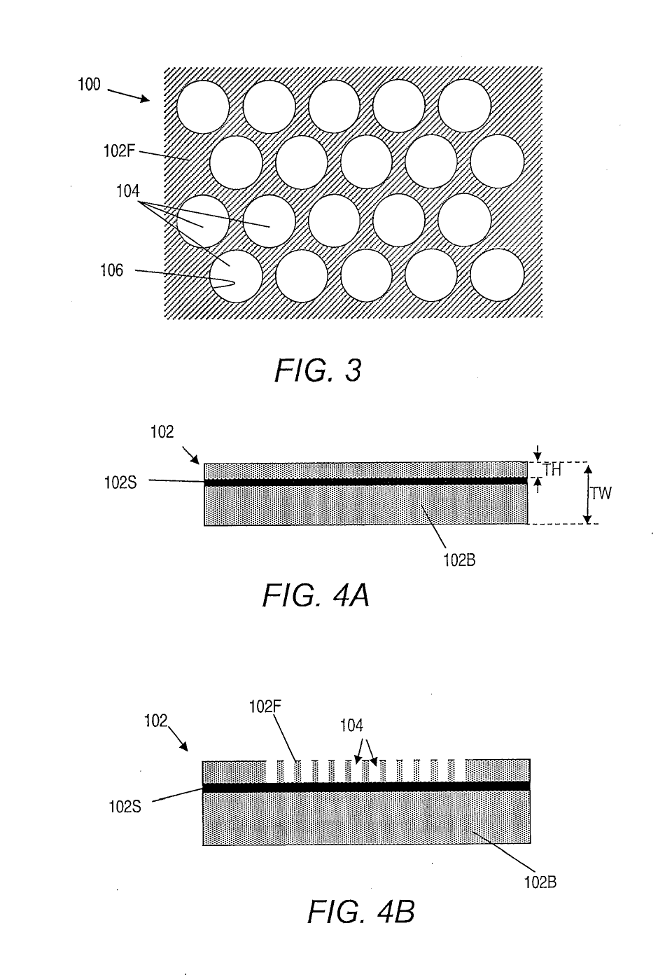

FIG. 3 is a schematic front face view of an embodiment of a spectral purity filter 100, that may for example be applied as an above-mentioned filter 11 of a lithographic apparatus. The present filter 100 is configured to transmit extreme ultraviolet (EUV) radiation. In a further embodiment, the filter 100 substantially blocks a second type of radiation generated by a radiation source, for example infrared (IR) radiation, for example infrared radiation of a wavelength larger than about 1 μm, particularly larger than about 10 μm. Particularly, the EUV radiation to be transmitted and the second type of radiation (to be blocked) can emanate from the same radiation source, for example an LPP source SO of a lithographic apparatus.

The spectral purity filter 100 in the embodiments to be described comprises a substantially planar filter part 102F (for example a filter film or filter layer). The filter part 102F as such can be called a ‘filter substrate’. The filter part 102F has a plurality of (preferably parallel) apertures 104 to transmit the extreme ultraviolet radiation and to suppress transmission of the second type of radiation. The face on which radiation impinges from the source SO will be referred to as the front face, while the face from which radiation exits to the illumination system IL can be referred to as the rear face. As is mentioned above, for example, the EUV radiation can be transmitted by the spectral purity filter without changing the direction of the radiation. In an embodiment, each aperture 104 has been manufactured by an anisotropic etching process, and has parallel sidewalls defining the apertures 104 and extending completely from the front to the rear face.

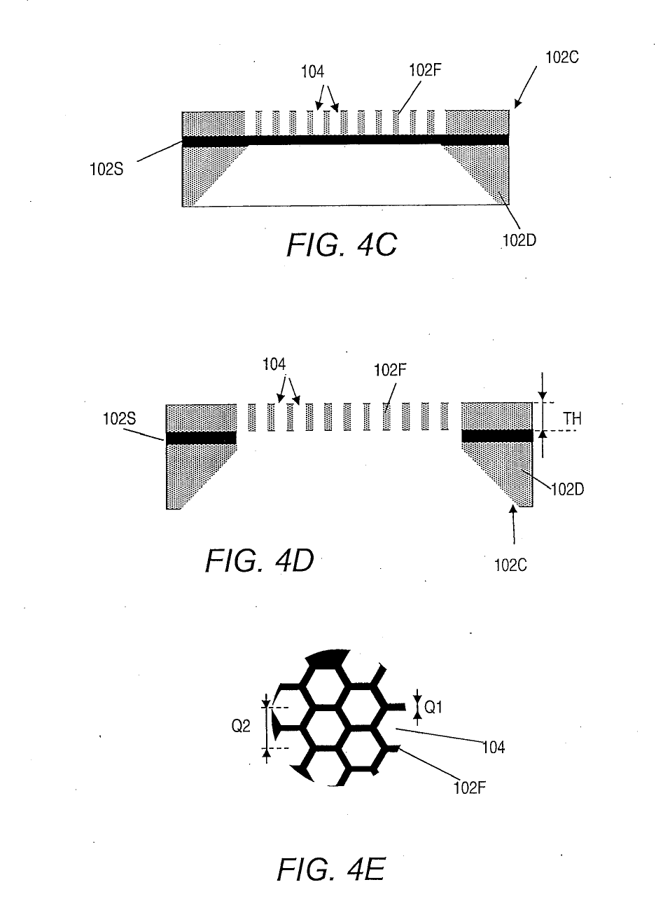

FIGS. 4A-4E show steps in an example process for manufacturing the filter part 102F. This process will be explained briefly below, while further detailed may be found in co-pending U.S. Provisional Patent Application No. 61/193,769 filed on Dec. 22, 2008, mentioned above. For example, the filter 100 may include a freestanding thin film of silicon (Si) 102F and an array of apertures 104 with substantially vertical (i.e. perpendicular to the film surface) sidewalls 106. The diameter of the apertures 104 is desirably larger than about 100 nm and more desirably larger than about 1 μm in order to allow EUV radiation to pass through the spectral purity filter 100 without substantial diffraction. Although the apertures 104 are shown schematically as having a circular cross section (in FIG. 3), other shapes are also possible, and can be desired. For example, hexagonal apertures (see FIGS. 4E, 5, 6, 8) may be advantageous from the point of view of mechanical stability. A wavelength to be suppressed by the filter 100 can be at least 10× the EUV wavelength to be transmitted. Particularly, the filter 100 is configured to suppress transmission of DUV radiation (having a wavelength in the range of about 100-400 nm), and/or infrared radiation having a wavelength larger than 1 μm (for example in the range of 1-11 microns).

According to a more particular embodiment of the invention, the spectral purity filter 100 may be manufactured by using an anisotropic etching method, of which a suitable example the technique of deep reactive ion etching (DRIE), described briefly below. DRIE is an etching method with highly anisotropic etch rates, which enables the manufacturing of vertical etch profiles in Si using the so-called Bosch process. This is described for example in S. Tachi, K. Tsujimoto, S. Okudaira, Low-temperature reactive ion etching and microwave plasma etching of silicon, Appl. Phys. Lett. 52 (1988), 616. The Bosch process consists of alternately exposing the Si surface to an SF₆ plasma and a fluorocarbon (e.g. C₄F₈) plasma. In the first stage, silicon is etched in a more or less isotropic way, whereas in the second stage, the etched profile is covered by a passivation layer. In the next etch, this passivation layer is opened preferentially at the bottom, mainly by ion bombardment, and etching starts again. By repetition of the etch/passivation cycle, the etch proceeds layer by layer downwards into the silicon surface, without lateral spreading.

An embodiment of the filter manufacturing method comprises (i) applying a hard mask of an aperture pattern on top of a freestanding thin Si film, and (ii) deep reactive ion etching the aperture pattern vertically through the entire Si film. An alternative embodiment of the manufacturing method comprises (i) applying a hard mask of an aperture pattern on a substrate with a Si surface, (ii) deep reactive ion etching the aperture pattern vertically into the Si surface to a desired depth, and (iii) removing the part of the substrate below the etched apertures.

Referring now to FIG. 4A, the example manufacturing method begins with a planar substrate 102 of silicon. The thickness TW of the substrate 102 is much greater initially than the thickness TH desired for filter part 102F.

Starting material 102 may comprise a SOI (silicon-on-insulator) wafer, for example a (crystalline) Si wafer with an oxide layer 102S buried at a specific depth, e.g. by oxygen ion implantation. The SOI wafer 102 thus consists of a top Si layer (film) 102F, a SiO₂ intermediate layer 102S, and a bottom Si layer 102B. For example, a thickness TW of the wafer can be smaller than 1 mm, for example 670 microns.

FIG. 4B shows the result of using DRIE, by which the aperture pattern (of hexagonal apertures) is etched in the top Si layer (from a front side) that will provide the filter part 102F of thickness TH. The SiO₂ layer 102S acts as an etch stop.

Subsequently, at least part-of the bottom Si layer 102B extending under the aperture pattern 104 is etched away using a KOH etch. Preferably, part of the bottom layer 102B is left standing to provide a respective (lower) section of a filter holder 102C. The result is shown in FIG. 4C. Again, the SiO₂ layer may act as an etch stop.

Finally, the SiO₂ may be removed using a buffered oxide etch, the result being depicted in FIG. 4D. Also in this case, preferably, only part of the etch stop layer 102S is removed, to open up the apertures 104, wherein a remaining part of the bottom layer 102S is left standing to provide a respective section of a filter holder 102C.

As follows from FIGS. 4C-4D, desirably, the filter 100 is provided with a filter holder 102C, external to the filter part 102F having the apertures 104. For example, the filter holder 102C can be configured to surround the filter part 102F. Preferably, the filter holder 102C is substantially thicker than the (in this embodiment central) filter part 102F. For example, a thickness of the holder 102C (measured in a direction parallel to the apertures 104) can be over 20 microns, for example at least 0.1 mm.

The present filter holder 102C is an integral part of the filter 100, substantially made of filter part (semiconductor) material. For example, the filter holder 102C can be a frame 102C surrounding the filter part 102F. In the present example, the filter holder 100C still contains part of the etch stop layer (being ‘buried’ in respective substrate material), and a support part 102D that is substantially thicker than the filter part 102F. In the present example, the filter part 102F and the support layer 102D are made from the same material.

FIG. 4E schematically shows part of the hexagonal apertures 104 in the substrate layer 102F, viewed again from the front face. Arrow Q1 indicates a thickness Q1 of the walls between the filter apertures 104. Arrow Q2 indicates the period of the apertures. The thickness Q1 can be relatively small by application of the present manufacturing method. Also, the (close packed) hexagonal structure of the walls of the filter part 102F provides a very durable and open configuration.

Advantageously, EUV radiation is directly transmitted through the apertures 104, preferably utilizing a relatively thin filter 100, in order to keep the aspect ratio of the apertures low enough to allow EUV transmission with a significant angular spread. Thickness TH of the filter part 102F (i.e. the length of each of the apertures 104) is for example smaller than about 20 μm, for example in the range of about 2 μm to about 10 μm, for example the range of about 5 μm to about 10 μm. Also, according to an embodiment, each of the apertures 104 may have a diameter in the range of about 100 nm to about 10 μm. Desirably, the apertures 104 each have diameter in the range of about 1.5 μm to about 6 μm, for example in the range of about 2 μm to about 4 μm.

Referring to the front detail view shown in FIG. 4E, thickness Q1 of the walls between the filter apertures 104 may be smaller than about 1 μm, for example in the range of about 0.2 μm to about 0.6 μm, particularly about 0.5 μm. The apertures of the EUV transmissive filter 100 may, have a period Q2 (indicated in FIG. 4E) of in the range of about 2 μm to about 6 μm, particularly about 3 μm to about 4 μm, for example about 4 μm. Consequently, the apertures may provide an open area of about 70-80% of a total filter front surface.

Advantageously, the filter 100 is configured to provide at most 5% infrared light (IR) transmission. Also, advantageously, the filter 100 is configured to transmit at least about 60% of incoming EUV radiation at a normal incidence. Besides, particularly, the filter 100 can provide at least about 40% of transmission of EUV radiation having an angle of incidence (with respect of a normal direction) of 10°.

The semiconductor filter part 102F produced by the process described above can perform as a spectral purity filter without modification. In an embodiment, modifications such as those to be described below can be implemented to improve filter performance and longevity. In an embodiment, according to the present invention, an additional layer or layers are provided to protect the semiconductor material from attack by the hydrogen or other radicals in the atmosphere. Embodiments include the filter part 102F being selected from one or more of: a semiconductor part, a crystalline semiconductor part, a doped semiconductor part, a coated semiconductor part, and an at least partly modified semiconductor part. Filter part 102F may contain at least one semiconductor material selected from silicon, germanium, diamond, gallium arsenide, zinc selenide, and zinc sulfide.

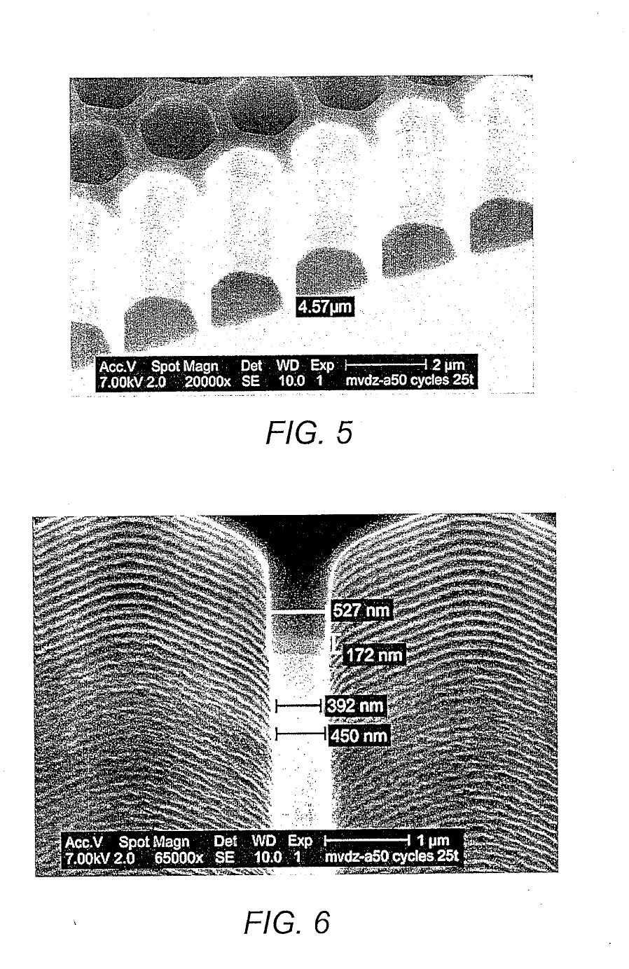

FIGS. 5 and 6 illustrate examples of spectral purity filters that have been manufactured in accordance with the process described above. FIG. 5 is an image of tilted cross sectional view of a spectral purity filter having apertures with a period of about 3 μm. The depth of the apertures (corrected for the viewing angle) is about 10.8 μm.

FIG. 6 is a close-up detail in a tilted cross section of a wall between two apertures. A top layer seen in FIG. 6 is an SiO₂ hard mask used for the Bosch process and has a thickness of about 400 nm when corrected for the viewing angle. As best seen in FIG. 6, the walls are textured, particularly ribbed or scalloped, and so have a periodic thickness variation along the surface of the wall. This scalloping effect arises from the cycles of etching and passivation in the described deep reactive ion etching (DRIE) process. Conventionally, the texture is minimized to the extent compatible with process practicalities and throughput. The inventors note, however, that the etching speed and/or duration of these cycles can be modified deliberately to provide an amplified texture, which may be applied to modify optical properties of the sidewall, as described below.

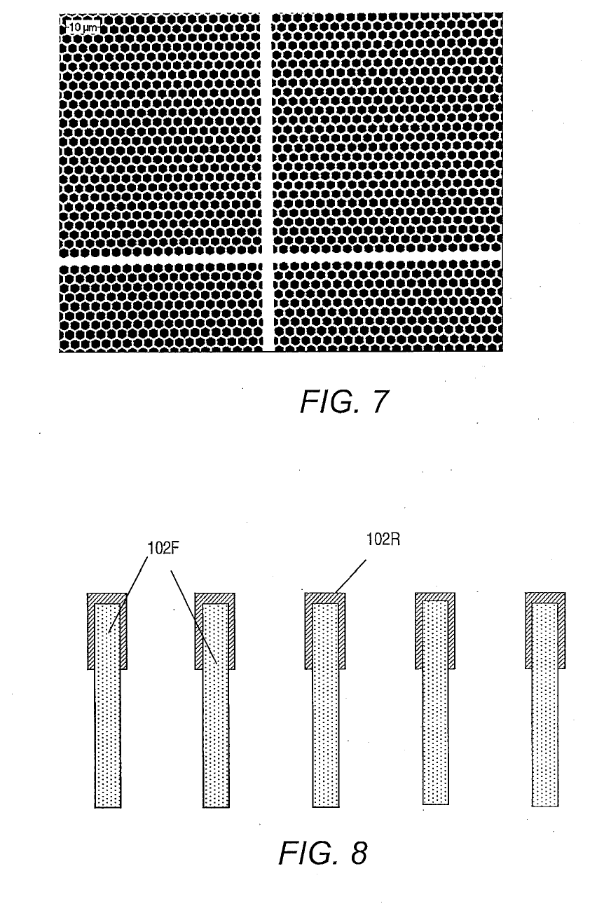

FIG. 7 is a top view of a freestanding spectral purity filter 100 in accordance with an embodiment of the present invention. Several grid SPF types can be distinguished based on different mechanisms for suppression of unwanted 10.6 μm radiation. The Si grid in accordance with embodiment of this invention may be modified according to the specifications of these grid types.

In a spectral purity filter, the infrared transmission should be low. This can be achieved by either absorbing or reflecting the incident radiation. Since absorption results in a high temperature of the filter, and thus lifetime issues can be expected, it is preferred to reflect the incident radiation. With their high complex refractive index in the infrared region, most metals are nearly ideal reflectors in that wavelength regime. Therefore, a metal coating may be used on the spectral purity filter grid in the embodiments described herein. Other reflectors can be used, such as SiC, TiN and RuOx as mentioned below, which are not all metallic.

FIG. 8 is a schematic cross section through a few of the sidewalls of the filter such as that shown in FIG. 7, after provision with a metal reflective layer 102R. The silicon grid filter part 102F is shown with its front face uppermost. The front face in this context is used to refer to the face on which the radiation to be transmitted and the radiation to be attenuated. The transmitted radiation, in this example EUV radiation, leaves the filter via the rear face, shown lowermost in FIG. 8 and subsequent Figures. It will be seen that the front face of the grid has been provided with a reflective capping layer 102R, to enhance reflectivity of the filter to the unwanted IR wavelengths. The reflective layer 102R in this example extends some distance along the sidewalls, rather than capping only the front face of the walls between apertures.

Simulation results obtained using the GSolver simulation package for a silicon filter grid with different forms of reflective layer 102R are given in co-pending patent application U.S. Provisional Patent Application No. 61/193,769 filed on Dec. 22, 2008, mentioned above. These results suggest that, where Mo is deposited only on the top surface of a silicon grid, a thick metal coating of about 2 μm may be desired to achieve the desired suppression of IR wavelengths. The metal thickness can be reduced by using a smaller period of the grid, but in that case the transmission of the wanted EUV radiation is also likely to be reduced. When the metal coating covers both the top surface and the sidewalls of the silicon grid, as shown in FIG. 8, however, the situation changes dramatically. In that case, IR transmission drops to nearly zero already for a coating of only a few nanometers thickness. At such small thickness, most power is absorbed in the grid. In order to make the grid substantially reflective, e.g. with 95% reflectivity, a coating of only about 30 nm, or less than about 50 nm, is needed. A thin coating is also beneficial for management of thermal stresses in operation.

One method to apply a reflective coating on the filter (for example silicon) grid with a minimal loss of EUV transmittance is by atomic layer deposition (ALD). In this way, a uniform coating thickness of a three-dimensional coating structure 102R can be achieved. Since the thickness of the coating is uniform, a desired infrared reflectivity can be achieved with a minimal loss of EUV transmittance due to excess coating thickness. Particularly, by application of ALD, excess coating thicknesses at the top of the grid can be avoided, while retaining sufficient coating thickness down the sidewalls 106 of the grid 102F. ALD uses alternating steps of a self-limiting surface reaction to deposit atomic layers one by one. The material to be deposited is provided through a precursor. ALD methods are known for several metals, for example, Mo, Ti, Ru, Pd, Ir, Pt, Rh, Co, Cu, Fe and Ni. An embodiment may use a reflective coating 102F consisting of Ruthenium (Ru) instead of Mo. Often it will be the case that Ru is already present in a system that is to utilize the filter. For example a lithographic apparatus may have an EUV source-collector module that comprises Ru. Alternatively, the reflective coating 102R may not a metal but another material that is reflective for the unwanted radiation, for example TiN or RuOx, or a conductor material.

Instead of ALD, galvanic growth (electrodeposition) may be used to deposit the reflective coating 102R. Metals can also be deposited on a Si grid, for example by evaporation or sputter deposition.

It may not be practical or desirable to apply a reflective coating that fully covers the sidewalls of a 10 μm thick grid. For example, it may be advantageous to leave the back side of the grid 102F uncoated to increase the emissivity and thus enhance radiative cooling of the grid. Therefore, in an embodiment, the coating is applied only partly down the sidewalls. For example, when the reflective coating is applied on top of the grid and down the first about 2 μm along the sidewalls of the grid, the optical behavior is essentially the same as when the whole sidewall is coated.

Although several different metals may be used, molybdenum is an attractive candidate because of its high melting point and proven vacuum compatibility. However, it turns out that, like many metals, molybdenum or ruthenium will form a silicide at elevated temperatures. Experiments show that a 20 nm Mo film on Si is completely silicidized after 24 hours at 800° C. A filter with this 20 nm Mo coating transmitted 0.7% of the incident 10.6 μm of the radiation before this treatment, while transmitting 11% afterwards. This shows that the optical properties of the silicide layer are less favorable than those of the unaffected metal layer. XPS analysis of the sample after treatment revealed a mixed layer containing both silicon and molybdenum on top of the silicon substrate. This confirms silicide formation. Clearly silicide formation directly affects the performance of the filter. Earlier experiments (on a different geometry) confirmed that even a 200 nm Mo layer was completely silicidized under the same conditions. The 200 nm Mo layer, after silicidation still had effective blocking of IR, but such a thick layer is also has drawbacks. One potential drawback is that thicker coating layers will tend to delaminate more than thin ones, under temperature cycling. Another potential drawback is that the coating, as it extends down the sidewalls into the aperture, reduces the opening and thereby reduces transmission of the wanted radiation (EUV in this example).

In order to prevent silicide formation, a new sample was made with a 20 nm silicon oxide (SiO₂) layer between the silicon substrate and a 200 nm molybdenum film. Both before and after heat treatment the infrared transmission of this sample was less than 0.1%. XPS analysis shows a pure molybdenum metal layer without silicon. A layer of 20 nm silicon oxide between metal and substrate may be sufficient to prevent silicide formation under the given conditions. From this, a thin Mo layer (for example in the range of about 10 nm to about 50 nm, for example about 20 nm) may resist silicidation and retain its optical properties during extended periods of use at high temperatures.

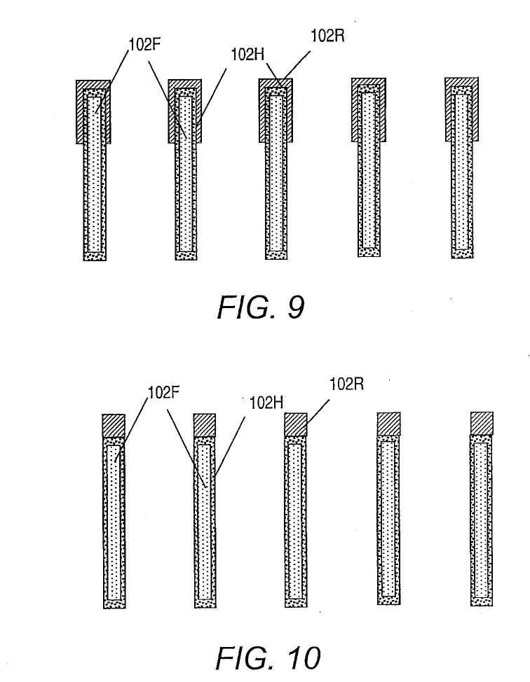

FIG. 9 shows a modified spectral purity filter part 102F in which a barrier layer 102H is formed over the entire exposed surface of the grid material, prior to application of the reflective metal layer 102R. FIG. 10 shows a modified filter part 102F in which a barrier layer is again applied before a metal reflective layer 102R, except that layer 102R is only on the front faces and does not extend down the sidewalls to any extent. As explained above, the benefit of the reflective layer is greatly enhanced if it extends down into the apertures.

Barrier layer 102H is of a material which prevents or significantly attenuates the formation of silicide by diffusion of material between the metal layer 102R and the underlying silicon grid material 102F. In a preferred embodiment, the material of the barrier layer 102H is selected also to be more resistant to attack by hydrogen radicals than the Si or other grid material. This is in accordance with an invention disclosed in co-pending U.S. Provisional Patent Application No. 61/222,001 filed on Jun. 30, 2009. As explained in that other application, the atmosphere in an EUV optical system such as an EUV lithography apparatus is expected to include quantities of atomic and/or molecular hydrogen among what is predominantly a vacuum environment. The H gas is introduced as a buffer and/or reactive agent to prevent/purge various contaminants. Unfortunately, the atomic H will attack the silicon material of filter part 102F.

Example materials for barrier layer 102H include: SiO₂ (silicon dioxide), mentioned in the experiments above, Si₃N₄ (silicon nitride), B₄C (boron carbide), C (carbon), Mo₂C (molybdenum carbide), MoSi₂ (molybdenum disilicide), WSi₂ (tungsten disilicide) and WC (tungsten carbide). B₄C, C, Mo₂C, MoSi₂, WSi₂ and WC are especially suitable to slow down interdiffusion of Mo/Si and W/Si interfaces. Other materials may be considered as barrier layer materials for other semiconductor substrates and other types of substrate material. Each of these materials has potential advantages and disadvantages in terms of optical properties, ease of manufacturing, compatibility with substrate material, reflective material and other layers, as discussed below.

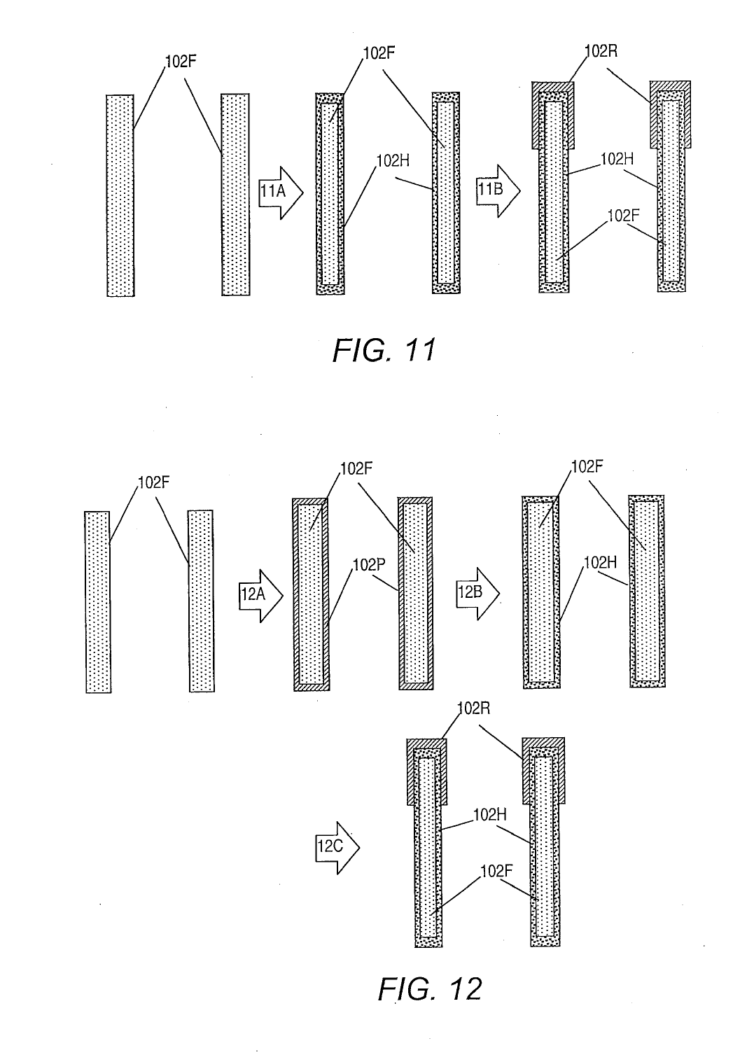

Three broad classes of process can be envisaged for the provision of the diffusion barrier layer 102H. In a first type of process, the material of the protective layer 102H is simply deposited on the grid material of filter part 102F, prior to deposition of the metal layer 102R. FIG. 11 illustrates a second type of process in which the protective material is formed by modifying a surface layer of the substrate material, such as silicon; in the filter part 102F. FIG. 12 illustrates a third and fourth type of process in which the protective layer 102H is applied by a two step process. In a first step (12A), a precursor material 102P is applied to the filter part 102F. In a second step (12B), the precursor material is modified by interaction with the environment, or modifies the substrate material, to form the protective material 102H.

These processes may be used alone or in combination with one another. Different materials and processes can in principle be used at different parts of the structure. Example processes are mentioned below for producing example protective materials, but these are not to be taken as the only processes applicable to produce a given material. The choice of process will also determine whether, for example, a uniform coating is achieved over all parts of the substrate, or whether certain faces are coated preferentially, and others only weakly if at all. In each case, a subsequent step is that of providing the metal reflective layer on top of the diffusion barrier layer. This is step 11B in FIG. 11 or step 12C in FIG. 12.

As mentioned above, besides SiO₂, it is likely that other diffusion barrier layers, such as for example B₄C can have the same beneficial effect. Si₃N₄ is another attractive material, since it can be formed on the grid by nitridization and is inert in a hydrogen atmosphere which may be present at the filter location.

For the example of Si₃N₄ layer 102H on a silicon substrate, the nitride material can be produced by the second type of method. The filter part 102F, already made into its grid form, is exposed to a flow of nitrogen radicals or ions (Step 11A). This may be a cold nitrogen plasma, for example. Interaction of these radicals with the silicon will form a thin film of Si₃N₄ on the surface, as shown after step 11A in the drawing. After that, in step 11B the metal layer such as Mo is formed, by ALD, sputter deposition or other process. The Si₃N₄ layer 102H acts as an effective diffusion barrier and the reflective properties of layer 102R remain intact after prolonged exposure to high temperatures. A thickness in the region of about 5 nm to about 20 nm is believed sufficient for the diffusion barrier to be effective over an extended period of use of the filter. Furthermore, at the rear portion of the filter where the reflective layer 102R is not covering the barrier layer 102H, the silicon material of filter part 102F is protected against hydrogen attack. Even a very thin layer protects against hydrogen attack. The thickness of the layer 102H may be for example less than about 50 nm, in particular in the range of about 5 nm to about 30 nm, or about 20 nm.

For producing SiO₂, it is well-known to heat the silicon substrate in an oxygen plasma or simply in O₂ atmosphere. A thickness in the region of about 5 nm to about 20 nm is believed sufficient for the diffusion barrier to be effective over an extended period of use of the filter. Where the metal coating is not applied, such as the rear portion of the filter, even a thin layer of SiO₂ can protect against hydrogen attack: about 1 nm to about 50 nm or about 5 nm to about 20 nm may be sufficient.

For a layer of B₄C, suitable processes will include CVD (chemical vapor deposition) or PVD (physical vapor deposition).

For the example of SiC layer 102H on a silicon substrate, the carbide material can be produced by modifying the surface layer of a silicon substrate. Exposing the substrate to methane (CH₄) in a near-vacuum and heating is one method. Again, with SiC a thin layer can protect against hydrogen attack: about 1 nm to about 50 nm. About 5 μm to about 20 μm is expected to provide an effective barrier against diffusion.

Each of the barrier materials has its own optical properties, as well as properties such as for hydrogen resistance. Silicon carbide SiC, in particular, has a relatively high reflectance in the unwanted IR wavelengths. Where optical properties are being exploited, the layer thickness may be dictated by the desired optical properties to be thicker than is desired simply for hydrogen shielding. A thin coating is beneficial for management of thermal stresses in operation, especially where the material has very different thermal expansion from the substrate. Too thick a coating may delaminate due to difference in the thermal expansion coefficients.

Typically, the diffusion barrier may fully enclose the grid structure, while the metal coating is only applied to the front side of the grid and inside the apertures (see FIGS. 1 & 2). In that case, the optical properties of the diffusion barrier will affect the emissivity of the back side of the grid. To optimize thermal radiation, it is preferable to choose a diffusion barrier material with high emissivity in the near-IR range. Si₃N₄ is very good in this respect, compared with pure silicon. In some SPFs, the 10.6 μm radiation or other unwanted radiation may be partially absorbed in the grid material. Such a grid can be realized with embodiment of the present invention by using doped Si. A typical embodiment according to this aspect of the invention comprises a Si grid with a doping concentration in excess of 10¹⁸ atoms/cm³. As explained in co-pending U.S. Provisional Patent Application No. 61/193,769, mentioned above, the refractive index of Si can be substantially changed by doping it with n-type impurities such as P or As. High values of doping can render the grid material substantially absorbing rather than transparent.

A manufacturing method for a doped Si grid may be the same as for a pure Si grid as described earlier, with the starting material comprising doped Si rather than pure Si. It is not expected that the doping will affect the DRIE process significantly. In alternative manufacturing methods, the doping may be introduced after manufacturing of the grid, for example by ion implantation or thermal diffusion. Whether or not this step is worth taking depends on the performance desired by the filter, and whether the other measures such as the reflective capping layers are sufficient to make other measures unnecessary.

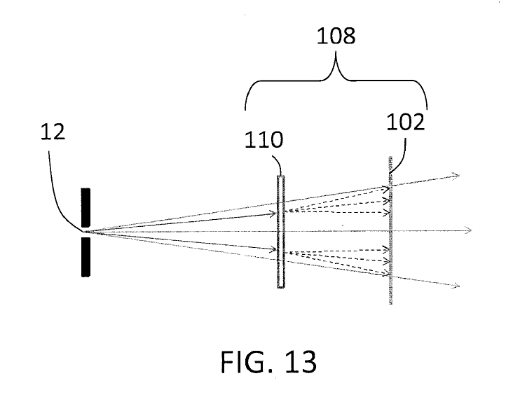

A filter system 108 may be provided with one or more spectral purity filters 100 and a diffuser 110 (see FIG. 13). The one or more of these spectral purity filters 100 may be configured to transmit extreme ultraviolet radiation. The spectral purity filter 100 may be a spectral purity filter 100 according to the present invention. The diffuser 110 is constructed and arranged to redistribute the second type of radiation. The diffuser 110 may be a further spectral purity filter. Alternatively, the diffuser 110 may be a Fresnel zone plate.

In addition to redistributing the second type of radiation, the diffuser 110 may protect the spectral purity filter 100. Although in FIG. 13 the diffuser 110 and the spectral purity filter 100 are located downstream along an optical path relative to the intermediate focus 12, the diffuser and the spectral purity filter 100 may, in another embodiment, be located somewhere else in the optical path.

An alternative or additional way to compensate for an inhomogeneous load of the second type of radiation is by providing different thicknesses of the barrier layer at different locations on the spectral purity filter. At some locations on the spectral purity filter, the barrier layer may even be completely absent. The transitions in barrier layer thickness may be gradual or they may be sharp.

It will be understood that the apparatus of FIGS. 1 and 2 incorporating the spectral purity filter with silicidation resistance may be used in a lithographic manufacturing process. Such lithographic apparatus may be used in the manufacture of ICs, integrated optical systems, guidance and detection patterns for magnetic domain memories, flat-panel displays, liquid crystal displays (LCDs), thin-film magnetic heads, etc. It should be appreciated that, in the context of such alternative applications, any use of the term “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The descriptions above are intended to be illustrative, not limiting. Thus, it should be appreciated that modifications may be made to the present invention as described without departing from the scope of the claims set out below.

It will be appreciated that embodiments of the invention may be used for any type of EUV source, including but not limited to a discharge produced plasma source (DPP source), or a laser produced plasma source (LPP source). However, an embodiment of the invention may be particularly suited to suppress radiation from a laser source, which typically forms part of a laser produced plasma source. This is because such a plasma source often outputs secondary radiation arising from the laser.

The spectral purity filter may be located practically anywhere in the radiation path. In an embodiment, the spectral purity filter is located in a region that receives EUV-containing radiation from the EUV radiation source and delivers the EUV radiation to a suitable downstream EUV radiation optical system, wherein the radiation from the EUV radiation source is arranged to pass through the spectral purity filter prior to entering the optical system. In an embodiment, the spectral purity filter is in the EUV radiation source. In an embodiment, the spectral purity filter is in the EUV lithographic apparatus, such as in the illumination system or in the projection system. In an embodiment, the spectral purity filter is located in a radiation path after the plasma but before the collector.

While specific embodiments of the present invention have been described above, it should be appreciated that the present invention may be practiced otherwise than as described.

What is claimed is:

1. A spectral purity filter configured to transmit extreme ultraviolet radiation, the spectral purity filter comprising a filter part having a plurality of apertures to transmit extreme ultraviolet radiation and to suppress transmission of a second type of radiation, the filter part comprising a carrier material, the spectral purity filter being provided on at least part of its surface with a layer of material opaque to said second type of radiation, wherein a barrier layer of different material is provided between said opaque material and the carrier material so as to inhibit diffusion of said carrier material into said opaque material under elevated temperatures.

2. The filter according to claim 1, wherein the filter part is substantially planar filter part, and wherein the plurality of apertures extend from a front to a rear surface of the filter part to transmit the extreme ultraviolet radiation incident on said front surface while suppressing transmission of a second type of radiation, said barrier layer and opaque material being provided on at least said front surface between the apertures.

3. The filter according to claim 2, wherein said reflective material extends at least about 1 μm along the sidewalls of the apertures.

4. The filter according to claim 1, wherein the material of said barrier layer extends over the substantially the whole surface of said carrier material, including areas not provided with said opaque material.

5. The filter according to claim 1, wherein said barrier layer comprises at least partly one material selected from the group of: silicon dioxide SiO₂, silicon nitride Si₃N₄, and boron carbide B₄C.

6. The filter according to claim 5, wherein said barrier layer comprises at least in part SiO₂.

7. The filter according to claim 5, wherein said barrier layer comprises at least in part Si₃N₄.

8. A lithographic apparatus comprising:
a radiation source configured to generate radiation comprising extreme ultraviolet radiation;
a illumination system configured to condition the radiation into a beam of radiation;
a support configured to support a patterning device, the patterning device being configured to pattern the beam of radiation;
a projection system configured to project a patterned beam of radiation onto a target material; and
a spectral purity filter configured to transmit the extreme ultraviolet radiation, the spectral purity filter comprising a filter part having a plurality of apertures to transmit extreme ultraviolet radiation and to suppress transmission of a second type of radiation, the filter part comprising a carrier material, the spectral purity filter being provided on at least part of its surface with a layer of material opaque to said second type of radiation, wherein a barrier layer of different material is provided between said opaque material and the carrier material so as to inhibit diffusion of said carrier material into said opaque material under elevated temperatures.

9. An apparatus according to claim 8, wherein said radiation source comprises a fuel delivery system and laser radiation source, the laser radiation source being arranged to deliver radiation at infrared wavelength onto a target comprising plasma fuel material delivered by said fuel delivery system for the generation of said extreme ultraviolet radiation, the radiation source thereby emitting a mixture of extreme ultraviolet and infrared radiation toward said spectral purity filter.

10. The apparatus according to claim 8, wherein a front surface of the filter part, between the apertures, is provided with said opaque material in the form of a metallic layer to enhance reflection of the second wavelengths, while the material of said barrier layer extends over substantially the entire surface of the filter part.

11. A method for manufacturing a transmissive spectral purity filter, configured to transmit extreme ultraviolet radiation, the method comprising:
etching a plurality of apertures in a substrate comprising carrier material using an anisotropic etching process to form a grid-like filter part, said apertures having a diameter much greater than a wavelength of said extreme ultraviolet radiation while being smaller than or comparable to a wavelength of second radiation to be suppressed;
providing a layer of diffusion barrier material over at least part of the surface of said carrier material; and
providing on top of at least part of said diffusion barrier layer a layer of material opaque to said second radiation, the diffusion barrier layer being effective under elevated temperatures to prevent diffusion of material between said carrier material of the filter part and the opaque material layer.

12. The method according to claim 11, wherein the material of said diffusion barrier layer is provided over portions of the carrier material which are not provided with said opaque material.

13. The method according to claim 12, wherein the opaque layer material extends from a front surface of the filter part down at least a part of each sidewall.

14. The method according to claim 11, wherein the opaque layer comprises molybdenum or tungsten.

15. The method according to claim 11, further comprising:
providing as said carrier material a semiconductor substrate having an etch stop layer;
using the anisotropic etching process to etch through the semiconductor substrate so that the apertures reach the etch stop layer; and
subsequently removing the etch stop layer.
